(19) United States
(12) Patent Application Publication
(10) Pub. No.: US 2022/0213259 A1
(43) Pub. Date: Jul. 7, 2022

(54) Curing agent composition for an epoxy resin compound, epoxy resin compound and multi-component epoxy resin system with improved low-temperature curing

(71) Applicant: Hilti Aktiengesellschaft, Schaan (LI)

(72) Inventors: Nicole BEHRENS, Munich (DE); Alexander Bornschlegl, Munich (DE)

(73) Assignee: Hilti Aktiengesellschaft, Schaan (LI)

(21) Appl. No.: 17/607,021

(22) PCT Filed: Apr. 20, 2020
(86) PCT No.: PCT/EP2020/060954

§ 371 Date: Oct. 27, 2021

(30) Foreign Application Priority Data
Apr. 30, 2019 (EP) 19171884.0

(51) Int. Cl. C08G 59/50

(52) U.S. Cl. CPC C08G 59/5033; C08G 59/5073; C08G 59/5026; C08G 59/5006

(57) ABSTRACT

A curing agent composition can be used for a multi-component epoxy resin compound for the chemical fastening of construction elements. An epoxy resin compound and a multi-component epoxy resin system are useful. A method can be used for the chemical fastening of construction elements in boreholes. A combination of a salt (S) with a phenol derivative can be used for the chemical fastening of construction elements, in particular at low temperatures (≤0° C.), to improve the curing and the pull-out strength.

The invention relates to a curing agent composition for a multi-component epoxy resin compound for the chemical fastening of construction elements, to an epoxy resin compound, and to a multi-component epoxy resin system. The invention further relates to a method for the chemical fastening of construction elements in boreholes. The invention also relates to the use of a combination of a salt (S) with a phenol derivative in an epoxy resin compound for the chemical fastening of construction elements, in particular at low temperatures (≤0° C.), to improve the curing and the pull-out strength.

Multi-component mortar compounds based on curable epoxy resins and amine curing agents have been known for some time and are used as adhesives and spackling pastes for repairing cracks and chemical anchors for fastening construction elements such as anchor rods, reinforcing bars, and screws in boreholes of various substrates. However, these mortar compounds often exhibit extremely long curing times at low temperatures ≤0° C. or it is not possible to achieve a sufficient curing reaction, such that the corresponding compounds are not suitable for the chemical fastening of construction elements due to the lack of or very poor load capacity (failure loads).

The prior art describes multi-component mortar compounds based on curable epoxy resins and amine hardeners which exhibit very good load capacity at high temperatures. The as yet unpublished European applications having the application numbers 18195417.3, 18195422.3 and 18195415.7, for example, describe multi-component epoxy resin systems in which the curing agent component is a salt (S) selected from the group consisting of salts of nitric acid, salts of nitrous acid, salts of halogens and salts of trifluoromethanesulfonic acid. These multi-component mortar compounds all exhibit insufficient load capacity as soon as they are applied into the borehole at low temperatures ≤0° C. and are cured at correspondingly low temperatures. Accordingly, it is not possible to use these multi-component mortar compounds in certain countries in winter or in countries having low average temperatures.

The problem addressed by the invention is therefore that of providing a curing agent component for multi-component epoxy resin compounds, the mortar compound produced from the multi-component epoxy resin compound being suitable for fastening purposes and having an improved pull-out strength at low temperatures (≤0° C.) compared to conventional mortar compounds. At the same time, the mortar compound produced from the multi-component epoxy resin compound should have a similar or, if possible, even slightly improved pull-out strength at standard temperatures (20 to 25° C.) compared to conventional mortar compounds.

The problem addressed by the invention is solved by a curing agent composition (B) according to claim 1. Preferred embodiments of the curing agent composition (B) according to the invention are provided in the dependent claims, which may optionally be combined with one another.

The invention further relates to an epoxy resin compound according to claim 9, and to a multi-component epoxy resin system according to claim 11. Preferred embodiments of the epoxy resin compound according to the invention and of the multi-component epoxy resin system are provided in the dependent claims, which may optionally be combined with one another.

The invention further relates to a method for the chemical fastening of construction elements in boreholes according to claim 13.

The invention further comprises the use of at least one salt (S) selected from the group consisting of salts of nitric acid, salts of nitrous acid, salts of halogens and salts of trifluoromethanesulfonic acid in combination with at least one phenol derivative for improving the pull-out strengths of epoxy resin compounds at low temperatures, preferably at ≤0° C., preferably in a range of from 0° C. to −10° C., according to claim 14.

According to the invention, a curing agent composition (B) for an epoxy resin compound is provided, which composition has at least one amine which is reactive to epoxy groups and, as an accelerator, at least one salt (S) selected from the group consisting of salts of nitric acid, salts of nitrous acid, salts of halogens, salts of trifluoromethanesulfonic acid and combinations thereof, the curing agent component (B) additionally comprising at least one phenol derivative as an accelerator.

The use of the curing agent composition (B) according to the invention in an epoxy resin compound for fastening purposes leads to a considerable improvement in the curing reaction at temperatures ≤0° C. and thus also to a considerable improvement in the pull-out strengths at temperatures ≤0° C. The cured compounds exhibit excellent pull-out strength at temperatures of ≤0° C., preferably in a range of from ≤0° C. to −10° C. Compared to conventional compounds, the compounds according to the invention can be loaded after a shorter time (90% of the reference load). The curing agent composition (B) according to the invention and the epoxy resin compounds prepared therefrom are therefore particularly suitable for use in countries having a cold temperature profile.

Within the context of the invention, the terms used above and in the following description have the following meanings:

“aliphatic compounds” are acyclic or cyclic, saturated or unsaturated carbon compounds, excluding aromatic compounds;

“cycloaliphatic compounds” are compounds having a carbocyclic ring structure, excluding benzene derivatives or other aromatic systems:

“araliphatic compounds” are aliphatic compounds having an aromatic backbone such that, in the case of a functionalized araliphatic compound, a functional group that is present is bonded to the aliphatic rather than the aromatic part of the compound;

“aromatic compounds” are compounds which follow Hückel's rule (4n+2);

“amines” are compounds which are derived from ammonia by replacing one, two or three hydrogen atoms with hydrocarbon groups, and have the general structures RNH₂ (primary amines), R₂NH (secondary amines) and R₃N (tertiary amines) (see: IUPAC Compendium of Chemical Terminology, 2nd ed. (the “Gold Book”), compiled by A. D. McNaught and A. Wilkinson, Blackwell Scientific Publications, Oxford (1997));

“salts” are compounds that are made up of positively charged ions (cations) and negatively charged ions (anions). There are ionic bonds between these ions. The expression “salts of nitric acid” describes compounds which are derived from nitric acid (HNO₃) and which comprise a nitrate (NO₃) as an anion. The expression “salts of nitrous acid” describes compounds which are derived from nitrous acid (HNO₂) and which comprise a nitrite (NO₂⁻) as an anion. The expression “salts of halogens” describes compounds which comprise an element from group 7 of the periodic table as an anion. In particular, the expression “salts of halogens” should be understood to mean compounds which comprise a fluoride (F⁻), chloride (Cl⁻), bromide (Br⁻) or iodide (I⁻) as an anion. The expression “salts of trifluoromethanesulfonic acid” describes compounds which are derived from trifluoromethanesulfonic acid (CF₃SO₃H) and which comprise a triflate (CF₃SO₃⁻) as an anion. In the context of the present invention, the term “salt” (S) also covers the corresponding hydrates of the salts. The salts (S) used as accelerators are also referred to as “salts” in the context of the present invention.

“Phenol derivatives” is a collective term for all compounds that are derived from phenol (empirical formula C₆H₅OH). In the case of the phenol derivatives, one or more of the hydrogen atoms bonded to the aromatic ring is substituted by hydrocarbon groups which optionally contain heteroatoms.

“Novolac resin” is the term for polycondensation products from formaldehyde or formaldehyde precursors with phenolic compounds, such as phenol, cresol, bisphenol A or F and cardanol derivatives.

According to the invention, the curing agent composition (B) comprises at least one amine which is reactive to epoxy groups. Corresponding amines are generally known to a person skilled in the art. Preferably, the at least one amine which is reactive to epoxy groups is selected from the group consisting of aliphatic, alicyclic, aromatic and araliphatic amines, and which has on average per molecule at least two reactive hydrogen atoms bonded to a nitrogen atom.

Examples of suitable amines which are reactive to epoxy groups are given below, but without restricting the scope of the invention: 1,2-diaminoethane(ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl-cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), 1,3-benzenedimethanamine (m-xylylenediamine, MXDA), 1,4-benzenedimethanamine (p-xylylenediamine, PXDA), 5-(aminomethyl)bicyclo[[2.2.1]hept-2-yl]methylamine (NBDA, norbomane diamine), dimethyldipropylenetramine, dimethylaminopropylaminopropylamine (DMAPAPA), 3-aminomethyl-3,5,5-trimethylcyclohexyl amine (isophorone diamine (IPDA)), diaminodicyclohexyl methane (PACM), diethylmethylbenzenediamine (DETDA), 4,4′-diaminodiphenylsulfone (dapsone), mixed polycyclic amines (MPCA) (e.g. Ancamine 2168), dimethyldiaminodicyclohexylmethane (Laromin C260), 2,2-bis(4-aminocyclohexyl)propane, (3(4),8(9)bis(aminomethyldicyclo[5.2.1.0^{2,6}]decane (mixture of isomers, tricyclic primary amines: TCD-diamine), methylcyclohexyl diamine (MCDA), N,N′-diaminopropyl-2-methylcyclohexane-1,3-diamine, N,N′-diaminopropyl-4-methylcyclohexane-1,3-diamine, N-(3-aminopropyl)cyclohexylamine, and 2-(2,2,6,6-tetramethylpiperidin-4-yl)propane-1,3-diamine.

Preferred amines in the curing agent composition (B) according to the invention are polyamines, such as 2-methylpentanediamine (DYTEK A), 3-aminomethyl-3,5,5-trimethylcyclohexane (IPDA), 1,3-benzenedimethanamine (m-xylylenediamine, MXDA), 1,4-benzenedimethanamine (p-xylylenediamine, PXDA), 1,6-diamino-2,2,4-trimethylhexane (TMD), diethylenetriamine (DETA), triethylenetetramine (TETA), tetraethylenepentamine (TEPA), pentaethylenehexamine (PEHA), N-ethylaminopiperazine (N-EAP), (3(4),8(9)bis(aminomethyl)dicyclo[5.2.1.0^{2,6}]decane (mixture of isomers, tricyclic primary amines; TCD-diamine), 1,14-diamino-4,11-dioxatetradecane, dipropylenetriamine, 2-methyl-1,5-pentanediamine, N,N′-dicyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylenedi- and triamines, 2,5-diamino-2,5-dimethylhexane, bis(amino-methyl)tricyclopentadiene, 1,8-diamino-p-menthane, bis(4-amino-3,5-dimethylcyclohexyl)methane, 1,3-bis(aminomethyl)cyclohexane (1,3-BAC), dipentylamine, N-2-(aminoethyl)piperazine (N-AEP), N-3-(aminopropyl)piperazine, piperazine and methylcyclohexyl diamine (MCDA).

The amines can be used both individually and in a mixture of two or more of the specified amines.

The amine(s) which is/are reactive to epoxy groups is/are preferably contained in the curing composition in a proportion of from 10 to 90 wt. %, particularly preferably from 35 to 70 wt. %, based on the total weight of the curing agent composition (B).

Thiols, dithiols and/or polythiols, preferably selected from the group consisting of aliphatic, alicyclic, aromatic and araliphatic thiols and mixtures thereof, can also be used as a replacement for the amines and/or as a further additive for the curing agent composition (B).

It is also possible for the at least one amine which is reactive to epoxy groups to comprise at least one Mannich base. This can be used alone or in combination with the above-mentioned amines. The Mannich bases used are the reaction products of an amine and an aldehyde with a phenolic compound selected from the group consisting of phenol, pyrocatechol, resorcinol, hydroquinone, hydroxyhydroquinone, phloroglucinol, pyrogallol, o-cresol, m-cresol, p-cresol, bisphenols such as bisphenol F or bisphenol A. and combinations thereof.

In order to form the Mannich base, the phenolic compound is reacted with a preferably primary or secondary amine and an aldehyde or an aldehyde precursor which results in an aldehyde as a result of decomposition. The aldehyde or the aldehyde precursor may advantageously be added to the reaction mixture as an aqueous solution, in particular at an elevated temperature of from approximately 50° C. to 90° C., and reacted with the amine and the phenolic compound.

Phenol or a styrenated phenol, resorcinol, styrenated resorcinol, bisphenol A or bisphenol F are preferably used as the phenolic compound for forming the Mannich base, with phenol or a styrenated phenol, styrenated resorcinol or bisphenol A particularly preferably being used.

The aldehyde used to form the Mannich base is preferably an aliphatic aldehyde, particularly preferably formaldehyde. Trioxane or paraformaldehyde, which decompose to form formaldehyde by being heated in the presence of water, can preferably be used as an aldehyde precursor.

The amine used for reacting with the aldehyde and the phenolic compound so as to form the Mannich base is preferably one of the above-mentioned amines, and preferably 1,3-benzenedimethanamine (MXDA), 3-aminomethyl-3,5,5-trimethylcyclohexane (IPDA), 1,3-bis(aminomethyl)cyclohexane (1,3-BAC), 1,2- and 1,4-diaminocyclohexane (1,2-DACH and 1,4-DACH), diaminodicyclohexyl methane (PACM), methylcyclohexyl diamine (MCDA) and 5-(aminomethyl)bicyclo[[2.2.1]hept-2-yl]methylamine (NBDA). The amine is preferably present in excess, such that the Mannich base has free amino groups.

The amine used for reacting with the aldehyde and the phenolic compound so as to form the Mannich base can also be an aminosilane selected from the group consisting of 3-aminoalkyltrialkoxysilanes, such as 3-aminopropyl-tri(m)ethoxysilane, 3-aminoalkylalkyl dialkoxysilane, such as 3-aminopropylmethyldi(m)ethoxysilane, N-(aminoalkyl)-3-aminoalkyltrialkoxysilanes, such as N-(2-aminoethyl)-3-aminopropyltri(m)ethoxysilane, N-(aminoalkyl)-3-aminoalkyl-alkyldialkoxysilanes, such as N-(2-aminoethyl)-3-aminopropylmethyldi(m)ethoxysilane, 3-[2-(2-aminoethylamino)ethylamino]propyltri(m)ethoxysilane, bis-(gamma-trimethoxysilylpropyl)amine, or mixtures thereof; or also selected from the group consisting of N-cyclohexyl-3-aminopropyltri(m)ethoxysilane, N-cyclohexylaminomethylmethyldiethoxysilane, N-cyclohexylaminomethyltriethoxysilane, 3-ureidopropyltri(m)ethoxysilane, N-methyl[3-(trimethoxysilyl)-propylcarbamate, N-trimethoxysilylmethyl-O-methylcarbamate and N-dimethoxy(methyl)silylmethyl-O-methylcarbamate.

In a preferred embodiment, the Mannich base is present in the curing agent composition (B) in a proportion of from 10 wt. % to 70 wt. %, preferably from 15 wt. % to 60 wt. %, more preferably from 20 wt. % to 50 wt. %, and particularly preferably from 25 wt. % to 40 wt. %, based on the total weight of the curing agent composition (B).

It is also possible for the at least one amine which is reactive to epoxy groups to comprise at least one benzoxazine-amine adduct. This can be used alone or in combination with the above-mentioned amines. The benzoxazine-amine adduct is selected from the group consisting of substances according to formula Ia, substances according to formula Ib and mixtures thereof, having the following structures:

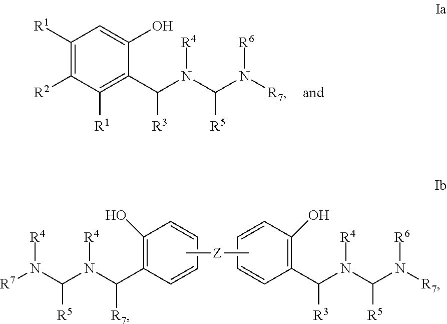

where R¹, R², R³, R⁴ and R⁵ are each independently selected from H, alkyl, cycloalkyl, heterocycloalkyl, aryl, heteroaryl, arylalkyl, heteroalkyl, alkoxy, hydroxyl, hydroxyalkyl, carboxyl, halo, haloalkyl, amino, aminoalkyl, alkylcarbonyloxy, arylcarbonyloxy, alkoxycarbonyl, alkylcarbonyl, alkylsulfonylamino, aminosulfonyl, sulfonic acid or alkylsulfonyl groups, and also from combinations of two or more of these groups, it being possible for the groups to each be unsubstituted or optionally substituted; where R⁶ and R⁷ each independently denote H or an amino, diamino or polyamino group selected from the group consisting of aliphatic, alicyclic, aromatic amine groups and also combinations of two or more of these groups, it being possible for the groups to each be unsubstituted or optionally substituted;
where Z is selected from a direct bond, —C(O)—, —S—, —O—, —S(O)—, —S(O)₂—, —C(R⁸)(R⁹)—, —[C(R⁸)(R⁹)]ₘ—C(R⁸)(R⁹)—[C(R¹⁰)(R¹¹)]ₙ—, —[C(R⁸)(R⁹)]ₘ—C(R⁸)(aryl)-[C(R¹⁰)(R¹¹)]ₙ—, —[C(R⁸)(R⁹)]ₘ—C(O)—[C(R¹⁰)(R¹¹)]ₙ—, —[C(R⁸)(R⁹)]ₘ—S—[C(R¹⁰)(R¹¹)]ₙ—, —[C(R⁸)(R⁹)]ₘ—O—[C(R¹⁰)(R¹¹)]ₙ—, —[C(R⁸)(R⁹)]ₘ—S(O)—[C(R¹⁰)(R¹¹)]ₙ—, —[C(R⁸)(R⁹)]ₘ—S(O)₂—[C(R¹⁰)(R¹¹)]ₙ—, a divalent heterocycle and —[C(R⁸)(R⁹)]ₘ-arylene-[C(R¹⁰)(R¹¹)]ₙ—, where m and n are each independently between 0 and 10, preferably between 0 and 5, and where R⁸, R⁹, R¹⁰ and R¹¹ each independently have the same meaning as the groups R¹ to R⁵.

For the benzoxazine-amine adducts according to structures Ia and Ib, it is preferred that R³ and R⁵ are each H.

Furthermore, Z is preferably selected from a direct bond, —C(R⁸)(R⁹)—, —C(R⁸)(aryl)-, —C(O)—, —S—, —O—, —S(O)—, —S(O)₂—, a divalent heterocycle and —[C(R⁸)(R⁹)]ₘ-arylene-[C(R¹⁰)(R¹¹)]ₙ—, where m and n are each independently between 0 and 5. Particularly preferably, Z is selected from a direct bond or —C(R⁸)(R⁹)—, where R⁸ and R⁹ are each independently selected from H or C₁-C₄ alkyl groups, preferably from H and methyl, or together form a divalent lactone group.

In an advantageous embodiment, R³ and R⁵ in the benzoxazine-amine adduct are each H, according to the structures Ia and Ib, and Z has the meaning given above.

In a preferred embodiment, the benzoxazine-amine adduct is present in the curing agent composition (B) in a proportion of from 10 wt. % to 70 wt. %, preferably from 15 wt. % to 60 wt. %, more preferably from 20 wt. % to 50 wt. %, and particularly preferably from 25 wt. % to 40 wt. %, based on the total weight of the curing agent composition (B).

The benzoxazine-amine adduct is obtained by reacting at least one benzoxazine component with at least one amine component, preferably an aromatic or araliphatic amine, a diamine component and/or polyamine component. Without restricting the scope of the invention, suitable benzoxazines for the preparation of the benzoxazine-amine adduct preferably have the following structure:

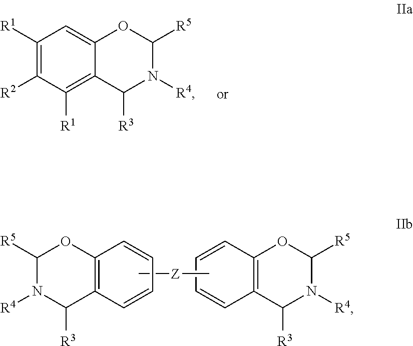

in which R¹ to R⁵ and Z have the meanings given above.

In advantageous embodiments of the benzoxazine component, R³ and R⁵ each denote H, and Z is selected from a direct bond, —C(R⁸)(R⁹)—, —C(R⁸)(aryl)-, —C(O)—, —S—, —O—, —S(O)—, —S(O)₂—, a divalent heterocycle and —[C(R⁸)(R⁹)]ₘ-arylene-[C(R¹⁰)(R¹¹)]ₙ—, where m and n are each independently between 0 and 5. Particularly preferably, Z is selected from a direct bond or —C(R⁸)(R⁹)—, where R⁸ and R⁹ are each independently selected from H or C₁-C₄ alkyl groups, preferably from H and methyl, or together form a divalent lactone group.

The benzoxazines are preferably selected from the following structures:

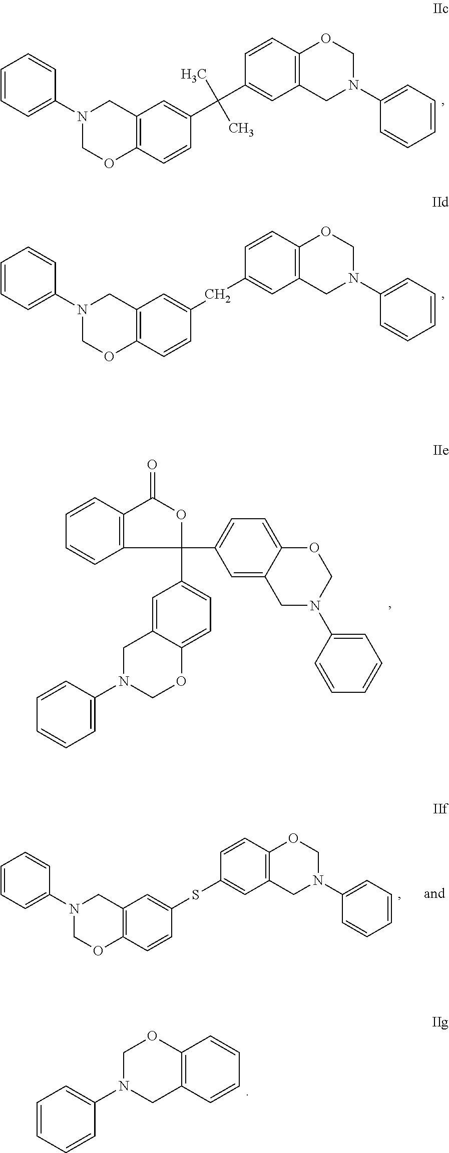 [SMILES: CC(C)(c1ccc2c(c1)CN(c1ccccc1)CO2)c1ccc2c(c1)CN(c1ccccc1)CO2 ; c1ccc(N2COc3ccc(Cc4ccc5c(c4)CN(c4ccccc4)CO5)cc3C2)cc1 ; O=C1OC(c2ccc3c(c2)CN(c2ccccc2)CO3)(c2ccc3c(c2)CN(c2ccccc2)CO3)c2ccccc21 ; c1ccc(N2COc3ccc(Sc4ccc5c(c4)CN(c4ccccc4)CO5)cc3C2)cc1 ; c1ccc(N2COc3ccccc3C2)cc1]

Without restricting the scope of the invention, suitable amines for the preparation of the benzoxazine-amine adduct are preferably selected from the group of the unbranched or branched C₂-C₁₀ alkyl diamines, the C₂-C₁₀ polyalkylene polyamines and the aromatic and araliphatic amines which preferably contain a substituted or unsubstituted benzene ring. The amine can be used either alone or as a mixture of two or more of the specified amines. An amine mixture which is composed of two or more amines has proven to be advantageous.

All of the substances mentioned above or mixtures thereof can be used as benzoxazine and amine components for the preparation of a benzoxazine-amine adduct. Various methods for the preparation of the benzoxazine-amine adduct are known to a person skilled in the art. To prepare the benzoxazine-amine adduct, one of the above-mentioned benzoxazine components is preferably dissolved in a solvent and reacted with the amine component at an elevated temperature. The amine is preferably added in excess. Instead of the solvent, the benzoxazine can also be dissolved in an excess of amine component. The reaction time is preferably 30 h or less, preferably 26 h or less and particularly preferably at most approximately 24 h.

According to the invention, the curing agent composition (B) contains at least one salt (S) as an accelerator. According to the invention, the salt (S) is at least one salt selected from the group consisting of salts of nitric acid, salts of nitrous acid, salts of halogens, salts of trifluoromethanesulfonic acid and combinations thereof. The salt (S) is preferably at least one salt selected from the group consisting of salts of nitric acid, salts of halogens, salts of trifluoromethanesulfonic acid and combinations thereof. It has been found to be particularly preferable for the salt (S) to be selected from the group consisting of nitrates (NO₃⁻), iodides (I⁻), triflates (CF₃SO₃⁻) and combinations thereof. The salt (S) particularly preferably is comprises at least one nitrate (NO₃⁻).

Alkali metal nitrates, alkaline earth metal nitrates, lanthanide nitrates, aluminum nitrate, ammonium nitrate and mixtures thereof are particularly suitable salts of nitric acid. Corresponding salts of nitric acid are commercially available. Alkali metal nitrates and/or alkaline earth metal nitrates, such as Ca(NO₃)₂ or NaNO₃, are preferably used as salts of nitric acid. It is also possible to use a solution of a salt in nitric acid as the salt (S), for example a solution containing Ca(NO₃)₂/HNO₃. To prepare this solution. CaCO₃ is dissolved in HNO₃.

Alkali metal nitrites, alkaline earth metal nitrites, lanthanide nitrites, aluminum nitrite, ammonium nitrite and mixtures thereof are particularly suitable salts of nitrous acid. Corresponding salts of nitrous acid are commercially available. Alkali metal nitrites and/or alkaline earth metal nitrites, such as Ca(NO₂)₂, are preferably used as salts of nitrous acid. Alkali metal halides, alkaline earth metal halides, lanthanide halides, aluminum halides, ammonium halides and mixtures thereof are particularly suitable salts of halogens. Corresponding salts of halogens are commercially available. The halogens are preferably selected from the group consisting of chloride, bromide, iodide and mixtures thereof, with iodides particularly preferably being used.

Alkali metal triflates, alkaline earth metal triflates, lanthanide triflates, aluminum triflate, ammonium triflate and mixtures thereof are particularly suitable salts of trifluoromethanesulfonic acid. Corresponding salts of trifluoromethanesulfonic acid are commercially available. Alkali metal nitrates and/or alkaline earth metal nitrates, such as Ca(CF₃SO₃)₂, are preferably used as salts of trifluoromethanesulfonic acid.

In principle, the cations of the salt (S) can be organic, inorganic or a mixture thereof. The cation of the salt (S) is preferably an inorganic cation.

Suitable organic cations are, for example, ammonium cations substituted with organic groups, such as C₁-C₆-alkyl groups, such as tetraethylammonium cations.

Suitable inorganic cations of the salt (S) are preferably cations selected from the group consisting of alkali metals, alkaline earth metals, lanthanides, aluminum, ammonium (NH₄⁺) and mixtures thereof, more preferably from the group consisting of alkali metals, alkaline earth metals, aluminum, ammonium and mixtures thereof, and even more preferably from the group consisting of alkali metals, alkaline earth metals, aluminum and mixtures thereof. It is particularly preferable for the cation of the salt (S) to be selected from the group consisting of sodium, calcium, aluminum, ammonium and mixtures thereof.

The following compounds or components are therefore particularly suitable as the salt (S): Ca(NO₃)₂ (calcium nitrate, usually used as Ca(NO₃)₂ tetrahydrate), a mixture of Ca(NO₃)₂/HNO₃, KNO₃ (potassium nitrate), NaNO₃ (sodium nitrate), Mg(NO₃)₂ (magnesium nitrate, usually used as Mg(NO₃)₂ hexahydrate), Al(NO₃)₃ (aluminum nitrate, usually used as Al(NO₃)₃ nonahydrate), NH₄NO₃ (ammonium nitrate), Ca(NO₂)₂ (calcium nitrite), NaCl (sodium chloride), NaBr (sodium bromide), NaI (sodium iodide), Ca(CF₃SO₃)₂ (calcium triflate), Mg(CF₃SO₃)₂ (magnesium triflate), and Li(CF₃SO₃)₂ (lithium triflate).

The curing agent composition (B) according to the invention can comprise one or more salts (S). The salts can be used both individually and in a mixture of two or more of the specified salts.

In order to improve the solubility properties of the salt (S) in the curing agent composition (B), the salt (S) can be dissolved in a suitable solvent and used accordingly as a solution. Organic solvents such as methanol, ethanol or glycerol, for example, are suitable for this purpose. However, water can also be used as the solvent, possibly also in a mixture with the above-mentioned organic solvents. In order prepare the corresponding salt solutions, the salt (S) is added to the solvent and stirred, preferably until it is completely dissolved.

The salt (S) is preferably contained in the curing agent composition (B) in a proportion of from 0.1 to 15 wt. %, based on the total weight of the curing agent composition (B). The salt (S) is preferably contained in the curing agent composition (B) in a proportion of from 0.2 to 12 wt. %, more preferably in a proportion of from 0.8 to 10 wt. %, even more preferably in a proportion of from 1.0 to 8.0 wt. %, based on the total weight of the curing agent composition (B).

According to the invention, the curing agent composition (B) additionally comprises at least one phenol derivative as an accelerator in addition to the at least one salt (S).

The phenol derivative is preferably selected from the group consisting of polyphenols from the group of novolac resins, styrenated phenols, phenolic lipids and combinations thereof. Compounds of the following formula (III) are preferably used as polyphenols from the group of novolac resins:

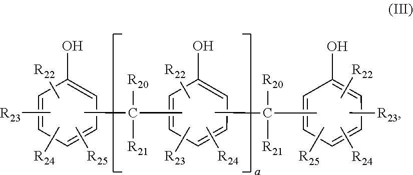

in which
   R₂₀ and R₂₁ each denote, independently of one another, H or —CH₃;
   R₂₂, R₂₃, R₂₄ and R₂₅ each denote, independently of one another, H, —CH₃ or an aliphatic functional group, preferably a linear, optionally partially unsaturated, unbranched hydrocarbon chain having up to 15 carbon atoms or an alkaryl functional group, preferably —C₈H₉; and where
   a is 0 to 20, preferably 0 to 15.

The polyphenol from the group of novolac resins particularly preferably corresponds to the following formula (IV):

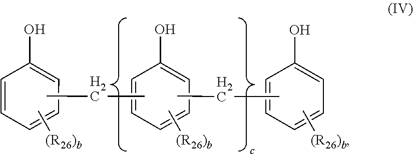

in which
   R₂₆ denotes a C₁-C₁₅ alkyl group, preferably a methyl group or tert-butyl group;
   b is 0, 1 or 2, and is preferably 1; and
   c is 0 to 15, and is preferably 0 to 6.

The novolac resin very particularly preferably corresponds to the above formula (IV), in which R₂₆ denotes CH₃ and b is 1 or 2, or R₂₆ denotes tert-butyl or a C₁-C₁₅ alkyl group and b is 1, and where c is 0 to 15, preferably 1 to 15.

The term styrenated phenols is understood to mean the electrophilic substitution products of phenols such as phenol, pyrocatechol, resorcinol, hydroquinone, hydroxyhydroquinone, phloroglucinol, pyrogallol, o-cresol, m-cresol or p-cresol with styrene or styrene analogs, such as vinyltoluene, vinylpyridine or divinylbenzene, in particular styrene. The styrenated phenol is particularly preferably selected from the reaction products of styrene and phenol which contain mixtures of compounds or individual compounds of the following formulas:

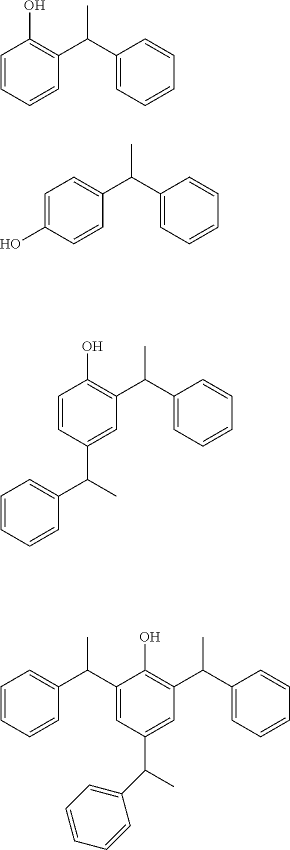

or 2,6-distyrylphenol, such as oligo- and polystyrene compound parts or compounds (products obtained from cationic polymerization of styrenes in phenols, oligomeric or polymeric products).

The term “phenolic lipids” is a collective term for a class of natural products that includes long aliphatic chains and phenolic rings. The phenolic lipid is preferably selected from alkyl catechols, alkyl phenols, alkyl resorcinols and anacardic acids. The at least one phenolic lipid is particularly preferably an alkylphenol selected from propylphenol, butylphenol, amylphenol, octylphenol, nonylphenol, dodecylphenol and cardanol-based compounds.

The curing agent composition (B) according to the invention can comprise one or more phenol derivatives. The phenol derivatives can be used both individually and in a mixture of two or more of the specified phenol derivatives.

The curing agent composition (B) according to the invention preferably contains the phenol derivative in a proportion of from 4 to 25 wt. %, preferably from 10 to 20 wt. %, based on the total weight of the curing agent composition.

In a preferred embodiment, the phenol derivative is at least one polyphenol selected from the group of novolac resins and is combined with a salt (S) selected from the group of nitrates.

The weight percent ratio of all phenol derivatives, in particular the polyphenols from the group of novolac resins, to all salts (S) in the curing agent composition (B) according to the invention is preferably 250:1 to 1:4, more preferably 40:1 to 1:2.

In a further advantageous embodiment, the curing agent composition (B) comprises at least one further additive selected from the group of further accelerators, adhesion promoters, thickeners and fillers.

Non-reactive diluents (solvents) may preferably be contained in amount of up to 30 wt. %, based on the total weight of the curing agent composition, for example from 1 to 20 wt. %. Examples of suitable solvents are alcohols, such as methanol, ethanol or glycols, lower alkyl ketones such as acetone, di-low-alkyl low-alkanoyl amides such as dimethylacetamide, low-alkyl benzenes such as xylenes or toluene, phthalic acid esters or paraffins. The amount of solvents is preferably ≤5 wt. %, based on the total weight of the curing agent composition.

Tertiary amines or imidazoles, organophosphines, Lewis bases or acids such as phosphoric acid esters, or mixtures of two or more thereof, can be used as further accelerators, for example.

The further accelerators are contained in the curing agent composition (B) in a proportion by weight of from 0.001 to 20 wt. %, preferably from 0.001 to 5 wt. %, based on the total weight of the curing agent composition (B). Examples of suitable further accelerators are in particular tris-2,4,6-dimethylaminomethylphenol, 2,4,6-tris(dimethylamino)phenol and bis[(dimethylamino)methyl]phenol. A suitable accelerator mixture contains 2,4,6-tris(dimethylaminomethyl)phenol and bis(dimethylaminomethyl)phenol. Mixtures of this kind are commercially available, for example as Ancamine® K54 (Evonik).

By using an adhesion promoter, the cross-linking of the borehole wall with the mortar compound is improved such that the adhesion increases in the cured state. Suitable adhesion promoters are selected from the group of silanes that have at least one Si-bound hydrolyzable group, such as 3-glycidoxypropyltrimethoxysilane, 3-glycidoxypropyltriethoxysilane, 2-(3,4-epoxycyclohexyl)ethyltrimethoxysilane, N-2-(aminoethyl)-3-aminopropylmethyl-diethoxysilane, N-2-(aminoethyl)-3-aminopropyl-triethoxysilane, 3-aminopropyl-trimethoxysilane, 3-aminopropyltriethoxysilane, N-phenyl-3-aminoethyl-3-aminopropyl-trimethoxysilane, 3-mercaptopropyltrimethoxysilane and 3-mercaptopropylmethyldimethoxysilane. In particular, 3-aminopropyl-trimethoxysilane (AMMO), 3-aminopropyltriethoxysilane (AMEO), 2-aminoethyl-3-aminopropyl-trimethoxysilane (DAMO) and trimethoxysilylpropyldiethylenetetramine (TRIAMO) are preferred as adhesion promoters. Further silanes are described, for example, in EP3000792 A1, the content of which is hereby incorporated in the present application.

The adhesion promoter can be contained in an amount of up to 10 wt. %, preferably from 0.1 to 8 wt. %, more preferably from 1.0 to 5 wt. %, based on the total weight of the curing agent composition.

Silicas are preferably used as thickeners. A thickener may be contained in an amount of up to 10 wt. %, preferably from 0.1 wt. % to 8 wt. %, based on the total weight of the curing agent composition (B).

Inorganic fillers, in particular cements such as Portland cement or aluminate cement and other hydraulically setting inorganic substances, quartz, glass, corundum, porcelain, earthenware, baryte, light spar, gypsum, talc and/or chalk and mixtures thereof are used as fillers. In addition, thickeners such as fumed silica can also be used as an inorganic filler. Particularly suitable fillers are quartz powders, fine quartz powders and ultra-fine quartz powders that have not been surface-treated, such as Millisil W3, Millisil W6, Millisil W8 and Millisil W12, preferably Millisil W12. Silanized quartz powders, fine quartz powders and ultra-fine quartz powders can also be used. These are commercially available, for example, from the Silbond product series from Quarzwerke. The product series Silbond EST (modified with epoxysilane) and Silbond AST (treated with aminosilane) are particularly preferred. Furthermore, it is possible for fillers based on aluminum oxide such as aluminum oxide ultra-fine fillers of the ASFP type from Denka, Japan (d₅₀=0.3 μm) or grades such as DAW or DAM with the type designations 45 (d₅₀<44 μm), 07 (d₅₀<9.4 μm), 05 (d₅₀<5.5 μm) and 03 (d₅₀<4.1 μm). Moreover, the surface-treated fine and ultra-fine fillers of the Aktisil AM type (treated with aminosilane, d₅₀=2.2 μm) and Aktisil EM (treated with epoxysilane, d50=2.2 μm) from Hoffman Mineral can be used.

The inorganic fillers can be added in the form of sands, flours, or molded bodies, preferably in the form of fibers or balls. The fillers can be present in one or all components of the multi-component epoxy resin system described below. A suitable selection of the fillers with regard to type and particle size distribution/(fiber) length can be used to control properties relevant to the application, such as rheological behavior, press-out forces, internal strength, tensile strength, pull-out forces and impact strength.

In an advantageous embodiment, the curing agent composition (B) has an AHEW (Amine Hydrogen Equivalent Weight) of from 20 to 1000 g/EQ, preferably from 30 to 500 g/EQ, more preferably from 40 to 350 g/EQ, even more preferably from 50 to 225 g/EQ, and particularly preferably from 50 to 150 g/EQ. The AHEW value is determined from the molecular weight (Mw) of the amine divided by the number of reactive hydrogen atoms per molecule (H eq.=Mw/functionality).

Experimentally, the AHEW can be obtained by determining the glass transition temperature (Tg) from a mixture of epoxy resin (with known EEW) and an amine component. In this case, the glass transition temperatures of epoxy resin/amine mixtures are determined with different ratios. The sample is cooled at a heating rate of −20 K/min from 21 to −70° C., heated in a first heating cycle to 250° C. (heating rate 10 K/min), then re-cooled to −70° C. (heating rate−20 K/min) and heated (20 K/min) to 200° C. in the last step. The mixture having the highest glass transition temperature in the second heating cycle (“Tg2”) has the optimum ratio of epoxy resin and amine. The AHEW value can be calculated from the known EEW and the optimum epoxy resin/amine ratio.
Example: EEW=158 g/mol
Amine/epoxy resin mixture having a maximum Tg2: 1 g amine with 4.65 g epoxy resin

$$AHEW ( amine ) = \frac{158}{4.65} = 34$$

The present invention further relates to an epoxy resin compound which comprises at least one curable epoxy resin and a curing agent composition (B) as described above. The epoxy resin compound is preferably a multi-component epoxy resin compound, more preferably a two-component epoxy resin compound.

A large number of the compounds known to a person skilled in the art and commercially available for this purpose which contain on average more than one epoxy group, preferably two epoxy groups, per molecule can be used as a curable epoxide. These epoxy resins may be both saturated and unsaturated as well as aliphatic, alicyclic, aromatic or heterocyclic, and may also have hydroxyl groups. They may also contain substituents which do not cause disruptive secondary reactions under the mixing or reaction conditions, for example alkyl or aryl substituents, ether groups and the like. Trimeric and tetrameric epoxies are also suitable in the context of the invention.

The epoxy resins are preferably glycidyl ethers which are derived from polyhydric alcohols, in particular from polyhydric phenols such as bisphenols and novolacs, in particular those having an average glycidyl group functionality of 1.5 or greater, in particular 2 or greater, for example from 2 to 10.

Examples of the polyhydric phenols used to prepare the epoxy resins are resorcinol, hydroquinone, 2,2-bis-(4-hydroxyphenyl)propane (bisphenol A), isomer mixtures of dihydroxyphenylmethane (bisphenol F), tetrabromobisphenol A, novolacs, 4,4′-dihydroxyphenylcyclohexane and 4,4′-dihydroxy-3,3′-dimethyldiphenylpropane.

The epoxy resin is preferably a diglycidyl ether of bisphenol A or bisphenol F or a mixture thereof. Liquid diglycidyl ethers based on bisphenol A and/or F having an epoxy equivalent weight (EEW) of from 150 to 300 g/EQ are particularly preferably used.

Further examples are hexanediol diglycidyl ether, trimethylolpropane triglycidyl ether, bisphenol A epichlorohydrin resins and/or bisphenol F epichlorohydrin resins, for example having an average molecular weight of Mn≤2000 g/mol.

The present invention further relates to a multi-component epoxy resin system comprising an epoxy resin component (A) and a curing agent component, the epoxy resin component (A) containing a curable epoxy resin, and the curing agent component comprising an amine which is reactive to epoxy groups. The multi-component epoxy resin system further comprises, as an accelerator, the combination of at least one salt (S) selected from salts of nitric acid, salts of nitrous acid, salts of halogens, salts of trifluoromethanesulfonic acid and combinations thereof and at least one phenol derivative.

The statements made above with regard to the amine which is reactive to epoxy groups, the salt (S) and the phenol derivative apply to the multi-component epoxy resin system according to the invention.

The salt (S) used as an accelerator can be contained in the epoxy resin component (A) or in the curing agent component or in both the epoxy resin component (A) and the curing agent component. The same applies to the phenol derivative. It is preferable for at least the salt (S) or the phenol derivative to be contained in the curing agent component. It is further preferred for both the salt (S) and the phenol derivative to be contained in the curing agent component. In this case, the curing agent composition (B) described above is used in the multi-component epoxy resin system.

The proportion of epoxy resin in the epoxy resin component (A) is >0 wt. % to 100 wt. %, preferably from 10 wt. % to 70 wt. % and particularly preferably from 30 wt. % to 60 wt. %, based on the total weight of the epoxy resin component (A).

In addition to the epoxy resins, the epoxy resin component (A) may optionally contain at least one reactive diluent. Glycidyl ethers of aliphatic, alicyclic or aromatic monoalcohols or in particular polyalcohols having a lower viscosity than epoxies containing aromatic groups are used as reactive diluents. Examples of reactive diluents are monoglycidyl ethers, e.g. o-cresyl glycidyl ether, and glycidyl ethers having an epoxide functionality of at least 2, such as 1,4-butanediol diglycidyl ether (BDDGE), cyclohexanedimethanol diglycidyl ether and hexanediol diglycidyl ether, as well as tri- or higher glycidyl ethers, such as glycerol triglycidyl ether, pentaerythritol tetraglycidyl ether, trimethylolpropane triglycidyl ether (TMPTGE), or trimethylolethane triglycidyl ether (TMETGE), with trimethylolethane triglycidyl ether being preferred. Mixtures of two or more of these reactive diluents can also be used, preferably mixtures containing triglycidyl ethers, particularly preferably as a mixture of 1,4-butanediol diglycidyl ether (BDDGE) and trimethylolpropane triglycidyl ether (TMPTGE) or 1,4-butanediol diglycidyl ether (BDDGE) and trimethylolethane triglycidyl ether (TMETGE).

The reactive diluents are preferably present in an amount of from 0 wt. % to 60 wt. %, more preferably from 1 wt. % to 20 wt. %, based on the total weight of the epoxy resin component (A).

Suitable epoxy resins and reactive diluents can also be found in the standard reference from Michael Dombusch, Ulrich Christ and Rob Rasing. “Epoxidharze,” Vincentz Network GmbH & Co. KG (2015), ISBN 13: 9783866308770. These compounds are included here by reference.

In a further embodiment, the epoxy resin component (A) can contain a co-accelerator, insofar as this co-accelerator is compatible with the epoxy resins. Tertiary amines or imidazoles, organophosphines, Lewis bases or acids such as phosphoric acid esters, or mixtures of two or more thereof, can be used as co-accelerators, for example. As mentioned above, these co-accelerators can also be present in the curing agent composition (B).

The proportion of the epoxy resin component (A) in relation to the total weight of the multi-component epoxy resin system is preferably from 5 wt. % to 90 wt. %, more preferably from 20 wt. % to 80 wt. %, even more preferably from 30 wt. % to 70 wt. % or yet more preferably from 40 wt. % to 60 wt. %.

The epoxy resins can have an EEW of from 120 to 2000 g/Eq, preferably from 140 to 400 g/Eq, in particular from 150 to 300 g/Eq. Mixtures of a plurality of epoxy resins may also be used.

The proportion of the curing agent component in relation to the total weight of the multi-component epoxy resin system is preferably from 10 wt. % to 95 wt. %, more preferably from 15 wt. % to 80 wt. %, even more preferably from 15 wt. % to 60 wt. % or particularly preferably from 20 wt. % to 40 wt. %.

Furthermore, the epoxy resin component (A) can contain conventional additives, in particular adhesion promoters and fillers, as already described for the curing agent composition (B).

The adhesion promoter can be contained in an amount of up to 10 wt. %, preferably from 0.1 to 5 wt. %, particularly preferably from 1.0 to 5.0 wt. %, based on the total weight of the epoxy resin component (A).

The inorganic fillers described above are preferably used as fillers. The fillers may also be present in one or all components of the multi-component epoxy resin system. The proportion of fillers is preferably from 0 wt. % to 90 wt. %, for example from 10 wt. % to 90 wt. %, preferably from 15 wt. % to 75 wt. %, more preferably from 20 wt. % to 50 wt. %, and even more preferably from 25 wt. % to 40 wt. %, based on the total weight of the multi-component epoxy resin system.

Further conceivable additives to the multi-component epoxy resin system are also thixotropic agents such as optionally organically after-treated fumed silica, bentonites, alkyl- and methylcelluloses and castor oil derivatives, plasticizers such as phthalic or sebacic acid esters, stabilizers, antistatic agents, thickeners, flexibilizers, curing catalysts, rheology aids, wetting agents, coloring additives such as dyes or pigments, for example for different staining of components for improved control of their mixing, as well as wetting agents, desensitizing agents, dispersants and other control agents for the reaction rate, or mixtures of two or more thereof.

Non-reactive diluents (solvents) may preferably also be contained in an amount of up to 30 wt. %, based on the total weight of the relevant component (epoxy resin component and/or curing agent component), for example from 1 wt. % to 20 wt. %. Examples of suitable solvents are alcohols, such as methanol or ethanol, lower alkyl ketones such as acetone, di-low-alkyl low-alkanoyl amides such as dimethylacetamide, low-alkyl benzenes such as xylenes or toluene, phthalic acid esters or paraffins.

Further additives of this kind may preferably be added in proportions by weight of a total of from 0 wt. % to 40 wt. %, based on the total weight of the epoxy resin component.

The multi-component epoxy resin system is preferably present in cartridges or film pouches which are characterized in that they comprise two or more separate chambers in which the epoxy resin component (A) and the curing agent component of the mortar compound are separately arranged so as to prevent a reaction.

For the use as intended of the multi-component epoxy resin system, the epoxy resin component (A) and the curing agent component are discharged out of the separate chambers and mixed in a suitable device, for example a static mixer or dissolver. The mixture of epoxy resin component (A) and curing agent component is then introduced into the previously cleaned borehole by means of a known injection device. The component to be fastened is then inserted into the epoxy resin compound and aligned. The reactive constituents of the curing agent component react with the epoxy resins of the epoxy resin component (A) by polyaddition such that the epoxy resin compound cures under environmental conditions within a desired period of time, preferably within hours.

Components of the multi-component epoxy resin system are preferably mixed in a ratio that results in a balanced stoichiometry according to the EEW and AHEW values.

The epoxy resin compound according to the invention or the multi-component epoxy resin system according to the invention is preferably used for construction purposes. The expression “for construction purposes” refers to the structural adhesion of concrete/concrete, steel/concrete or steel/steel or one of said materials with other mineral materials, to the structural strengthening of components made of concrete, brickwork and other mineral materials, to reinforcement applications with fiber-reinforced polymers of building objects, to the chemical fastening of surfaces made of concrete, steel or other mineral materials, in particular the chemical fastening of construction elements and anchoring means, such as anchor rods, anchor bolts, (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. Most particularly preferably, the epoxy resin compounds according to the invention and the multi-component epoxy resin system according to the invention are used for the chemical fastening of anchoring means.

The present invention also relates to a method for the chemical fastening of construction elements in boreholes, an epoxy resin compound according to the invention or a multi-component epoxy resin system according to the invention being used as described above for the chemical fastening of the construction elements. The method according to the invention is particularly suitable for the structural adhesion of concrete/concrete, steel/concrete or steel/steel or one of said materials with other mineral materials, for the structural strengthening of components made of concrete, brickwork and other mineral materials, for reinforcement applications with fiber-reinforced polymers of building objects, for the chemical fastening of surfaces made of concrete, steel or other mineral materials, in particular the chemical fastening of construction elements and anchoring means, such as anchor rods, anchor bolts, (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. The method according to the invention is very particularly preferably used for the chemical fastening of anchoring means.

The present invention also relates to the use of at least one salt (S) selected from the group consisting of salts of nitric acid, salts of nitrous acid, salts of halogens, salts of trifluoromethanesulfonic acid and combinations thereof and at least one phenol derivative as an accelerator in an epoxy resin compound for the chemical fastening of construction elements, in particular for anchoring fastening elements in boreholes, preferably for improving the curing reaction and the pull-out strengths at temperatures ≤0° C., preferably preferably in a range of from ≤0° C. to −10° C. It is preferable for the epoxy resin compound to be in the form of a multi-component epoxy resin system which comprises the epoxy resin component (A) described above and a curing agent component. It is also preferable for the salt (S) and the phenol derivative to be contained in the curing agent component and thus for a curing agent composition (B) as described above to be used as a curing agent component.

The use of a combination of at least one salt (S) within the meaning of the present invention and a phenol derivative as an accelerator in an epoxy resin compound, in particular in a multi-component epoxy resin system, makes it possible to shorten the curing time of the epoxy resin compound at temperatures ≤0° C. and correspondingly to considerably improve the pull-out strengths at temperatures ≤0° C., in particular in a range of from ≤0° C. to −10° C.

Further advantages of the invention can be found in the following description of preferred embodiments, which are not understood to be in any way limiting, however. All embodiments of the invention can be combined with one another within the scope of the invention.

### EXAMPLES

### Epoxy Resin Component (A)

Starting Materials

In the examples, the bisphenol A-based and bisphenol F-based epoxy resins, commercially available under the names Araldite GY 240 and Araldite GY 282 (Huntsman), respectively, were used as the epoxy resins.

3-Glycidyloxypropyl-trimethoxysilane, available under the name Dynalsylan GLYMO™ (Evonik Industries), was used as the adhesion promoter.

1,4-Butanediol-diglycidyl ether and trimethyolpropane-triglycidyl ether, commercially available under the names Araldite DY-026 and Araldite™ DY-T (Huntsman), respectively, were used as the reactive diluents.

The liquid components were premixed by hand. Subsequently, quartz (Millisil™ W12 or Millisil W4™ from Quarzwerke Frechen) was added as a filler and fumed silica (Cab-O-Sil™ TS-720 from Cabot Rheinfelden or Aerosil R 805 from Evonik) was added as a thickener and the mixture was stirred in the dissolver (PC laboratory system, volume 1 L) for 10 minutes at a negative pressure of 80 mbar at 3500 rpm.

The composition of the epoxy resin components A1 to A9 used in the examples is given in table 1 below.

TABLE 1
Compositions of the epoxy resin components Al to A9 in wt. %

| | Al | A2 | A3 | A4 | AS | A6 | A7 | A8 | A9 |
|---|---|---|---|---|---|---|---|---|---|
| 3-Glycidy- | 3.4 | 3.4 | 3.4 | 3.4 | 3.4 | 3,4 | 3.4 | 3.4 | 3.4 |
| loxypropyi- | | | | | | | | | |
| trimettioxysysilane | | | | | | | | | |
| Bisphenol A-based | 34.6 | 34.2 | 31.0 | 27.9 | 31.1 | 33.1 | 32.7 | 29.4 | 29.3 |
| epoxy resin | | | | | | | | | |
| Bisphenol F-based | 18.6 | 18.4 | 16.7 | 15.0 | 16.8 | 17.8 | 17.6 | 15.8 | 15.8 |
| epoxy resin | | | | | | | | | |
| 1,4-Butanediol | 6.7 | 6.6 | 6.0 | 5.4 | 6.0 | 6.4 | 6.3 | 5.7 | 5.6 |
| diglycidyi ether | | | | | | | | | |
| Trirnethyloipropane | 6.7 | 6.6 | 6.0 | 5.4 | 6.0 | 6.4 | 6.3 | 5.7 | 5.6 |
| triglycidyi ether | | | | | | | | | |
| Quartz (W12) | 27.4 | 28.7 | 34.2 | 41.1 | 33.9 | 30.2 | | | |
| Quartz (W4) | | | | | | | 31.3 | 38.0 | 38.1 |
| Silica (Aerosil) | | | 2.7 | | 2.8 | 2.8 | | | |
| Silica (Cab-O-Sil) | 2.7 | 2.2 | | 1.8 | | | 2.4 | 2.1 | 2.1 |
| EEW [g/Eq] | 230 | 232 | 255 | 282 | 254 | 240 | 242 | 269 | 269 |

The composition of the epoxy resin components VA1 to VA9 used in the comparative examples is given in table 2 below.

TABLE 2
Compositions of the epoxy resin components VA1 to VA9 in wt. %

| | VA1 | VA2 | VA3 | VA4 | VA5 | VA6 | VA7 | VA8 | VA9 |
|---|---|---|---|---|---|---|---|---|---|
| 3-Glycidy- | 3.4 | 3.4 | 3.4 | 3.4 | 3.4 | 3.4 | 3.4 | 3.4 | 3.4 |
| loxypropyl- | | | | | | | | | |
| trimethoxysysilane | | | | | | | | | |
| Bisphenol A-based | 34.0 | 39.0 | 39.1 | 25.9 | 31.1 | 32.2 | 32.0 | 29.1 | 29.0 |
| epoxy resin | | | | | | | | | |
| Bisphenol F-based | 18.3 | 21.0 | 15.7 | 13.9 | 16.7 | 17.3 | 17.2 | 15.7 | 15.6 |
| epoxy resin | | | | | | | | | |
| 1,4-butahediol | 6.5 | 7.5 | 5.6 | 5.0 | 6.0 | 6.2 | 6.2 | 5.6 | 5.6 |
| diglycidyl ether | | | | | | | | | |
| Trimethylolpropane | 6.5 | 7.5 | 5.6 | 5.0 | 6.0 | 6.2 | 6.2 | 5.6 | 5.6 |
| triglycidyl ether | | | | | | | | | |
| Quartz (W12) | 29.0 | 18.8 | 38.3 | 44.8 | 33.9 | 32.0 | | | |
| Quartz (W4) | | | | | | | 32.7 | 38.0 | 38.8 |
| Silica (Aerosii) | | | 2.3 | | 2.7 | 2.7 | | | |
| Silica (Cab-O-Sil) | 2.2 | 2.8 | | 2.0 | | | 2.4 | 2.1 | 2.1 |
| EEW [g/Eq] | 233 | 204 | 271 | 303 | 254 | 246 | 248 | 271 | 272 |

Curing Agent Composition (B)

Starting Materials

m-Xylylenediamine (MXDA) and 1,3-cyclohexanedimethanamine (1,3-BAC) from MGC, Japan, 2-methyl-1,5-pentamethylene diamine (Dytek A) from Invista, the Netherlands, 3-aminomethyl-3,5,5-trimethylcyclohexane (isophorone diamine, IPDA, trade name Vastamin IPD) from Evonik Degussa, Germany, methylcyclohexanediamine (Baxxodur EC 210, MCDA) from BASF SE, Germany, N-(2-aminomethyl)piperazine (N-AEP) from TCI Europe and 4,4′-methylene-bis-cyclohexylamine (PACM) from Evonik were used as amines for the preparation of the curing agent composition (B).

Quartz (Millisil™ W12 or Millisil™ W4 from Quarzwerke Frechen) and calcium aluminate cement (Secar 80 from Kemeos SA) were used as a filler and fumed silica (Cab-O-Sil™ TS-720 from Cabot Rheinfelden or Aerosil R 805 from Evonik) was used as a thickener.

Salts (S) and Phenol Derivatives

The constituents given in table 3 below were used to prepare the salts (S), novolac resins and further accelerators used in the curing agent composition (B).

TABLE 3
List of salts (S), novolac resins and further accelerators used

| Salt (S) or accelerator | Trade name | Manufacturer |
|---|---|---|
| Calcium nitrate | Calcium nitrate tetrahydrate | Sigma-Aldrich |
| Calcium carbonate | Calcium carbonate | Sigma-.Aldrich |
| Nitric acid 70% | Nitric acid | Sigma-Aldrich |
| Calcium triflate | Calcium | Sigma-Aldrich |
| | trifluoromethanesulfonate | |
| | Phenolite TD-2131 | DIC Europe |
| CNSL-based novolac | Cardolite NC-370 | Cardolite |
| (cashew nut shell liquid, | | Specialty |
| CNSL) | | Chemicals |
| Cardanol | Cardolite NX-2026 | Cardolite |
| | | Specialty |
| | | Chemicals |
| Cresol novolac | Phenolite KA 1160 | DIC Europe |
| Phenol modified | Novares CA 80 | Rutgers |
| indeneoumarone resin | | Novares GmbH |
| Styrenated phenol | Novares LS 500 | Rutgers |
| | | Novares GmbH |
| Salicylic acid | Salicylic acid | Merck |
| 2,4,6-Tris(dimethylamino- | Ancamin K54 | Evonik |
| methyl)phenol, | | |
| bis[(dimethylamino)methyl]- | | |
| phenol | | |

The salt calcium nitrate was used as a solution in glycerol (1,2,3-propanetriol, CAS No. 56-81-5, Merck, G). To prepare the calcium nitrate solution, 400.0 g calcium nitrate tetrahydrate was added to 100.0 g glycerol and stirred at 50° C. until completely dissolved (3 hours). The solution prepared in this way contained 80.0% calcium nitrate tetrahydrate.

A calcium nitrate/nitric acid solution was also used as the accelerator. To prepare this solution, 52.6 g calcium carbonate was slowly added to 135.2 g nitric acid and then stirred for 5 minutes.

### Examples 1 to 9

The liquid components were mixed to prepare the curing composition (B) of the following examples B1 to B9. If the phenol derivative used as the accelerator was a solid, it was added to the solution and dissolved at a slightly increased temperature (up to 50° C.) with stirring. Liquid phenol derivatives and the salt (S) were added and quartz powder and silicic acid were then added and stirred in the dissolver (PC laboratory system, volume 1 L) for 10 minutes at a negative pressure of 80 mbar at 2500 rpm.

The composition of the curing agent compositions (B) prepared in this way is given in table 4 below:

TABLE 4
Composition of the curing agent composition (B) in wt. %

| | Example | B1 | B2 | B3 | B4 | B5 | B6 | B7 | B8 | B9 |
|---|---|---|---|---|---|---|---|---|---|---|
| Amine | mXDA | 8.0 | 12.0 | — | 32.2 | 32.2 | — | — | — | — |
| | DYTEK A | 32.2 | 28.2 | 32.2 | — | — | 32.2 | — | — | — |
| | IPDA | — | — | 8.0 | 8.0 | — | — | — | — | — |
| | MCDA | — | — | — | — | — | — | — | — | — |
| | 1,3-BAC | — | — | — | — | — | 8.0 | 42.0 | 42.0 | 31.5 |
| | N-AEP | — | — | — | — | — | — | 8.0 | 8.0 | 5.6 |
| | PACM | — | — | — | — | — | — | — | — | 13.0 |
| Phenol | Phenolite TD-2131 | 10.2 | 11.5 | — | — | — | — | 10.2 | — | 10.0 |
| derivative | CNSL-based novolac | — | — | 10.1 | — | — | — | — | — | — |
| | Cardolite NX-2026 | — | — | — | 10.1 | — | — | — | — | — |
| | Cresol-based novolac | — | — | — | — | 10.0 | — | — | — | — |
| | Phenol modified indene- | — | — | — | — | — | 10.2 | — | — | — |
| | cournarone resin | | | | | | | | | |
| | Styrenated phenol | — | — | — | — | — | — | — | 20.0 | — |
| Salt (S) | Calcium nitrate | 3.8 | 2.5 | 6.3 | 6.3 | — | 3.8 | 3.8 | 3.8 | 3.8 |
| | Calcium nitrate/nitric | — | — | — | — | 4.0 | — | — | — | — |
| | acid | | | | | | | | | |
| Further | Ancarnin K54 | 2.4 | 2.4 | | — | 2.4 | 2.4 | 2.4 | — | — |
| accelerators | | | | | | | | | | |
| | Quartz (Millisil W4) | 39.0 | 41.2 | 34.0 | 40.5 | 40.5 | 39.3 | 31.3 | 22.9 | 34.2 |
| | Thickener (Cab-o-Sil) | 4.4 | 2.2 | | 2.9 | | | 2.3 | 3.3 | 1.9 |
| | Thickener (Aerosil) | | | 3.4 | | 2.9 | 4.1 | | | |
| | AHEW [g/Eq] | 74 | 75 | 77 | 88 | 77 | 75 | 73 | 73 | 79 |

### Comparative Examples 1 to 9

The liquid components were mixed to prepare the curing agent composition (B) of the following comparative examples VB1 to VB5. If the phenol derivative used as the accelerator was a solid, it was added to the solution and dissolved at a slightly increased temperature (up to 50° C.) with stirring. Liquid phenol derivative and the salt (S) were added and quartz powder and silica were then added and stirred in the dissolver (PC laboratory system, volume 1 L) for 10 minutes at a negative pressure of 80 mbar at 2500 rpm.

Table 5 shows the composition of the curing agent components (B) of comparative examples VB1 to VB9.

TABLE 5
Composition of the curing agent compositon (B) in wt.%

| | Compacative example | VBI | VB2 | VB3 | VB4 | VB5 | VB6 | VB7 | VB8 | VB9 |
|---|---|---|---|---|---|---|---|---|---|---|
| Amine | mXDA | 8.0 | 8.0 | — | 32.2 | 32.2 | — | — | — | — |
| | DYTEK A | 32.2 | 32.2 | 32.2 | — | — | 32.2 | — | — | — |
| | IPDA | — | 8.0 | 8.0 | — | — | — | — | — | — |
| | MCDA | — | — | — | 8.0 | — | — | — | — | — |
| | 1,3-BAC | — | — | — | — | — | 8.0 | 42.0 | 42.0 | 31.5 |
| | N-AEP | — | — | — | — | — | — | 8.0 | 8.0 | 5.6 |
| | PACM | — | — | — | — | — | — | — | — | 13.0 |
| Phenol | Phenolite TD-2131 | 14.0 | — | — | — | — | — | 14.0 | — | 10.0 |
| derivative | CNSL-based novolac | — | — | 14.0 | — | — | — | — | — | — |
| | Caudate NX-2026 | — | — | — | 16.4 | — | — | — | — | — |
| | Cresol-based novolac | — | — | — | — | 14.0 | — | — | — | — |
| | Phenol modified indene- | — | — | — | — | — | 14.0 | — | — | — |
| | coumarone resin | | | | | | | | | |
| Salt (S) | Calcium nitrate | 6.3 | — | — | — | — | — | 3.8 | — | — |
| Further | Ancamin K54 | 2.4 | 2.4 | 2.4 | — | 2.4 | 2.4 | 2.4 | — | — |
| accelerants | Salicylic acid | — | — | — | — | — | — | — | 4.0 | 4.0 |
| | Styrenated phenol | — | — | — | — | — | — | — | 19.8 | — |
| | Quartz (Millisil W4) | 41.3 | 48.5 | 38.9 | 40.5 | 40.3 | 39.4 | 31.3 | 23.2 | 33.6 |
| | Thickener (Cab-o-Sil) | 2.1 | 2.6 | — | 2.9 | — | — | 2.3 | 3.0 | 2.3 |
| | Thickener (Aeros1) | — | — | 4.5 | — | 3.1 | 4.0 | — | — | — |
| | AHEW [g/Eq] | 74 | 74 | 77 | 88 | 77 | 75 | 73 | 73 | 79 |

Mortar Compounds and Pull-Out Tests

The epoxy resin components A1 to A9 and VA1 to VA9 were each filled with the curing agent composition B1 to B9 and VB1 to VB9, respectively (A1 with B1, A2 with B2, VA1 with VB1 etc.), in hard cartridges at a volume ratio of 3:1 and injected into the borehole via a static mixer (Quadro™ mixer from Sulzer). The injection is usually carried out at room temperature. For the tests for curing at −5° C., the mortar compound is temperature-controlled to +5° C. and injected into the borehole.

The pull-out strength of the mortar compounds obtained by mixing the epoxy resin component (A or VA) and curing agent composition (B or VB) according to the above examples was determined using a high-strength anchor threaded rod M12 according to ETAG 001 Part 5, which was doweled into a hammer-drilled borehole having a diameter of 14 mm and a borehole depth of 69 mm by means of the relevant mortar compound in C20/25 concrete. The boreholes were cleaned by means of compressed air (2×6 bar), a wire brush (2×) and again by compressed air (2×6 bar).

The boreholes were filled up, by two thirds from the bottom of the borehole, with the mortar compound to be tested in each case. The threaded rod was pushed in by hand. The excess mortar was removed using a spatula. After the curing time and temperature specified for the relevant test, the failure load was determined by centrally pulling out the threaded anchor rod with close support. The following tests were carried out:

A1

Dry concrete, embedding depth 68 mm, curing 24 hours at 25° C., support confined;

A23, −5° C., 168 hours

Dry concrete, embedding depth 68 mm, curing 168 hours at −5° C. (substrate temperature), mortar compound temperature when setting the anchor rod +5° C.

The load values obtained with the mortar compounds using the epoxy resin components A1 to A9 and VA1 to VA9 and the curing agent components B1 to B39 and VB1 to VB9 according to examples 1 to 9 and comparative examples 1 to 9 are shown in tables 5 and 6 below, respectively.

TABLE 6
Determination of the load values of the examples according to the invention by pull-out tests

| | Examples | | | | | | | | |
|---|---|---|---|---|---|---|---|---|---|
| | 1 | 2 | 3 | 4 | 5 | 6 | 7 | 8 | 9 |
| Pull-out tests | Load value [N/mm²] | | | | | | | | |
| Al | 38.1 | 34.6 | 34.5 | 32.9 | 33.4 | 29.9 | 35.4 | 37.4 | 35.7 |
| A23, −5° C., | 40.4 | 28.1 | 32.5 | 34.8 | 31.5 | 33.4 | 19.6 | 22.5 | 21.0 |
| 168 h | | | | | | | | | |

TABLE 7
Determination of the load vaiues of the comparative exampies by put-out tests

| | Comparative examples | | | | | | | | |
|---|---|---|---|---|---|---|---|---|---|
| | 1 | 2 | 3 | 4 | 5 | 6 | 7 | 8 | 9 |
| Pull-out tests | Load value [N/mm²] | | | | | | | | |
| Al | 34.1 | 33.1 | 32.8 | 23.2 | 33.9 | 31.0 | 37.2 | 35.3 | 37.7 |
| A23, −5° C., 168 h | 25.1 | 30.3 | 31.8 | 33.3 | 28.3 | 29.0 | 18.2 | 19.7 | 18.9 |

The pull-out tests show that the mortar compounds of the examples according to the invention each have significantly higher load values during curing and pulling out at −5° C. than the mortar compounds of the comparative examples.

Determination of the Gel Time by Temperature Measurement

To determine the gel time by temperature measurement, 100 g of a mixture of the epoxy resin component (A) with the curing agent component (B) were poured into a 150 ml plastic container in a volume ratio of 3:1. A temperature sensor was placed in the center of the plastics container. The temperature change was recorded (device: Yokogawa, DAQ station, model: DX1006-3-4-2). With this method, the curing of the mortar could be followed over the course of the temperature development. If there was an acceleration during curing, the maximum temperature is shifted to shorter times, associated with a higher temperature. Tₘₐₓ (maximum temperature reached) and t_{T}_{ₘₐₓ} (time after which the maximum temperature was reached) were measured. The gel time correlates with the time that remains for the user to process the mixed mortar before curing. A long gel time with simultaneously rapid curing is advantageous for the user.

The gel times for examples 1 according to the invention and comparative examples 1 and 2 were determined. The only difference between these three examples is the accelerator combination. Example 1 according to the invention had a gel time of 6:38 minutes, comparative example 1 a considerably longer gel time of 17:51 minutes and comparative example 2 had a gel time of 5:10 minutes. However, the curing of comparative example 1 is still not complete even after 168 hours at −5° C. Comparative example 2 and example 1 exhibit acceptable load values after 168 hours at −5° C., but example 1 has the most advantageous combination for the user of the longest possible processing time and high final load after 168 hours. The combination according to the invention of phenolic accelerator and inorganic salt therefore achieves the best overall property profile.

1: A curing agent composition (B) for a multi-component epoxy resin compound, comprising:
at least one amine which is reactive to epoxy groups, and
as an accelerator, at least one salt (S) selected from the group consisting of salts of nitric acid, salts of nitrous acid, salts of halogens, salts of trifluoromethanesulfonic acid, and combinations thereof,
wherein the curing agent composition (B) further comprises at least one phenol derivative as an accelerator.

2: The curing agent composition (B) according to claim 1, wherein the at least one phenol derivative is selected from the group consisting of polyphenols from the group of novolac resins, styrenated phenols, phenolic lipids, and combinations thereof.

3: The curing agent composition (B) according to claim 1, wherein the at least one salt (S) is selected from the group consisting of nitrates (NO₃⁻), iodides (I⁻), triflates (CF₃SO₃⁻), and mixtures thereof.

4: The curing agent composition (B) according to claim 1, wherein the at least one phenol derivative comprises at least one polyphenol from the group of novolac resins, which corresponds to the following formula: 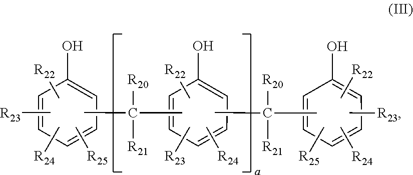
in which
R₂₀ and R₂₁ each denote, independently of one another, H or —CH₃;
R₂₂, R₂₃, R₂₄ and R₂₅ each denote, independently of one another, H, —CH₃, an aliphatic functional group, or an alkaryl functional group, and
wherein a is 0 to 20.

5: The curing agent composition (B) according to claim 4, wherein the at least one polyphenol from the group of novolac resins corresponds to the following formula: 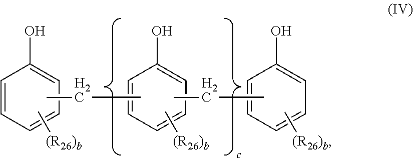
in which
R₂₆ denotes a C₁-C₁₅ alkyl group,
b is 0, 1 or 2, and
c is 0 to 15.

6: The curing agent composition (B) according to claim 1, wherein the at least one phenol derivative comprises at least one polyphenol from the group of novolac resins and the at least one salt (S) is selected from the group consisting of nitrates.

7: The curing agent composition (B) according to claim 1, wherein the at least one amine which is reactive to epoxy groups is selected from 2-methylpentanediamine (DYTEK A), 3-aminomethyl-3,5,5-trimethylcyclohexane (IPDA), 1,3-benzenedimethanamine (m-xylylenediamine, MXDA), 1,4-benzenedimethanamine (p-xylylenediamine, PXDA), 1,6-diamino-2,2,4-trimethylhexane (TMD), diethylenetriamine (DETA), triethylenetetramine (TETA), tetraethylenepentamine (TEPA), pentaethylene hexamine (PEHA), N-ethylaminopiperazine (N-EAP), (3(4),8(9)bis(aminomethyl)dicyclo[5.2.1.0^{2,6}] decane, 1,14-diamino-4,11-dioxatetradecane, dipropylenetriamine, 2-methyl-1,5-pentanediamine, N,N′-dicyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylenedi- and triamines, 2,5-diamino-2,5-dimethylhexane, bis(amino-methyl)tricyclopentadiene, 1,8-diamino-p-menthane, bis-(4-amino-3,5-dimethylcyclohexyl)methane, 1,3-bis(aminomethyl)cyclohexane (1,3-BAC), dipentylamine, N-2-(aminoethyl)piperazine (N-AEP), N-3-(aminopropyl)piperazine, piperazine, methylcyclohexyl-diamine (MCDA), and combinations thereof.

8: The curing agent composition (B) according to claim 1, wherein the at least one salt (S) comprises a cation from the group consisting of alkali metals, alkaline earth metals, lanthanoids, aluminum, ammonium, and combinations thereof.

9: An epoxy resin compound, containing at least one curable epoxy resin and the curing agent composition (B) according to claim 1.

10: The epoxy resin compound according to claim 9, wherein the epoxy resin compound is a multi-component epoxy resin compound.

11: A multi-component epoxy resin system comprising:
an epoxy resin component (A) and a curing agent component,
wherein the epoxy resin component (A) contains a curable epoxy resin, and the curing agent component contains at least one amine which is reactive to epoxy groups, and
wherein the epoxy resin component (A) and/or the curing agent component contains, as an accelerator, at least one salt (S) selected from the group consisting of salts of nitric acid, salts of nitrous acid, salts of halogens, and salts of trifluoromethanesulfonic acid; and at least one phenol derivative.

12: The multi-component epoxy resin system according to claim 11, wherein the at least one salt (S) and the at least one phenol derivative are contained in the curing agent component.

13: A method, comprising:
chemical fastening of construction elements in boreholes using the epoxy resin compound according to claim 9.

14: A method for improving the pull-out strength of an epoxy resin compound at low temperatures, the method comprising:
mixing at least one salt (S) selected from the group consisting of salts of nitric acid, salts of nitrous acid, salts of halogens, and salts of trifluoromethanesulfonic acid, with at least one phenol derivative; to form an accelerator for an epoxy resin compound.

15: The curing agent composition (B) according to claim 4, wherein in the formula (III), R₂₂, R₂₃, R₂₄ and R₂₅ each denote, independently of one another, H, —CH₃, an aliphatic functional group, or an alkaryl functional group,
wherein the aliphatic functional group is a linear, optionally partially unsaturated, unbranched hydrocarbon chain having up to 15 carbon atoms, and/or
wherein the alkaryl functional group is —C₈H₉.

16: A method, comprising:
chemical fastening of construction elements in boreholes using the multi-component epoxy resin system according to claim 11.
